(19) United States
(12) Patent Application Publication
(10) Pub. No.: US 2006/0279488 A1
(43) Pub. Date: Dec. 14, 2006

(54) Drive apparatus and drive method for light emitting panel

(75) Inventor: Akinori Hayafuji, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Yamagata (JP)

(21) Appl. No.: 11/435,805

(22) Filed: May 18, 2006

(30) Foreign Application Priority Data
Jun. 9, 2005 (JP) 2005-168997

(51) Int. Cl. G09G 3/30

(52) U.S. Cl. 345/76

(57) ABSTRACT

The present invention aims to ease intense rush current which is supplied to a drive voltage generation means (DC-DC converter) for supplying a drive voltage to a light emitting panel, as a dimmer setup value of the light emitting panel is changed. A constant electric current value supplied to a monitoring element Ex is controlled based on the dimmer setup value. Based on a forward voltage Vf produced at this time, an output voltage VA of a DC-DC converter 4 is controlled and provided as a drive voltage VA for the light emitting panel. A control signal Vda changed based on re-setup of the dimmer value is changed slowly over a predetermined time period by means of a control signal conversion means 5 which constitutes a time constant circuit, and controls the constant electric current value supplied to the monitoring element Ex. Especially when the dimmer value is changed to raise the brightness of the light emitting panel, it is possible to ease the rush current supplied from a battery to the DC-DC converter 4 which supplies the drive voltage VA to the light emitting panel.

### BACKGROUND OF THE INVENTION

1. Field of the Invention

The present invention relates to a drive apparatus and a drive method for causing and driving a light emitting panel to emit light in which one or more light emitting elements are arranged, and in particular to a drive apparatus and a drive method for a light emitting panel which allow reducing stress applied to a power supply circuit etc. when a dimmer setup value for controlling luminescent brightness of a light emitting panel is changed.

2. Description of the Related Art

Since mobile phones, personal digital assistant terminals (PDA), etc., are widespread, there is an increasing demand for a display panel which has a high definition image display function and can realize a thin shape and low power consumption. Thus, conventionally, a liquid crystal display panel has been employed in a large number of products as a display panel which fulfils the demand. On the other hand, a display panel has been recently realized using an organic EL (electroluminescence) element which takes advantage of a characteristic of being a self-emitting type display element, thus attracting attention as a next-generation display panel which replaces the conventional liquid crystal display panel. There is also part of the background that a light-emitting functional layer of an element employs an organic compound which can expect a good light-emission property, so that the organic EL display panel has as high an efficiency and long a lifetime as can be put into practical use.

The above-mentioned organic EL element is basically arranged such that a transparent electrode of ITO (Indium Tin Oxide), a light-emitting functional layer made from an organic substance, and a metal electrode are stacked in order on a transparent substrate of glass etc., for example. Further, the above-mentioned luminescence functional layer may be arranged to be a single layer of an organic luminescence layer, a two-layer structure constituted by an organic electron-hole transportation layer and an organic luminescence layer, a three-layer structure constituted by an organic electron-hole transportation layer, an organic luminescence layer, and an organic electron-transportation layer, or a multilayer structure in which an electron or electron hole injecting layer is further inserted between suitable ones of these layers.

The above-mentioned organic EL element can be electrically represented in an equivalent circuit as shown in FIG. 1. In other words, the organic EL element can be represented by a structure including a diode component E as a light-emitting element and a parasitic capacitance component Cp combined in parallel with the diode component E, and it is thought that the organic EL element may be a capacitive light-emitting element.

As for this organic EL element, when a light-emitting drive voltage is applied, charge which is equivalent to capacitance of the element first flows into an electrode as displacement current and is accumulated. Then, if a fixed voltage (light-emitting threshold voltage=Vth) inherent to the element is exceeded, electric current begins to flow from one electrode (anode side of the diode component E) into an organic layer which constitutes a light-emitting layer. Thus, the EL element may be considered to emit light at an intensity proportional to the electric current.

FIG. 2 shows light-emission static characteristics of such an organic EL element. According to this, the organic EL element emits light at a brightness L substantially proportional to drive electric current I as shown in FIG. 2(a). As shown by a solid line in FIG. 2(b), when a drive voltage V is greater than the light-emitting threshold voltage Vth, the electric current I flows rapidly so that light is emitted.

In other words, when the drive voltage is equal to or less than the light-emitting threshold voltage Vth, the electric current little flows into EL element, and does not emit light. Therefore, as shown by a solid line in FIG. 2(c) brightness properties of the EL element are such that the higher the voltage V to be applied is, the greater the emission brightness L becomes in a light emittable region where the drive voltage is greater than the above-mentioned the threshold voltage Vth.

On the other hand, it is known that the above-mentioned organic EL element changes in properties of the element and a forward voltage Vf becomes large when used over an extended period. For this reason, as shown in FIG. 2(b), a V-I (L) property (property as shown by a dashed line) of the organic EL element changes with actual operating time in the direction as shown by an arrow, therefore the brightness properties are also reduced.

Furthermore, it is also known that the brightness properties of the organic EL element generally change with temperature as shown by a dashed line in FIG. 2(c). In other words, in the light emittable region where the drive voltage is greater than the above-mentioned light-emitting threshold voltage, the EL element has the property that the larger the value of the voltage V applied to it is, the greater the emission brightness L is, while the higher the temperature is, the smaller the light-emitting threshold voltage becomes. Therefore, EL element is in a situation where light can be emitted with a smaller applied voltage at a higher the temperature, and has temperature dependent brightness where it is bright at a high temperature and dark at a low temperature even if the same voltage capable of emitting light is applied.

As described above, the EL elements change in emission brightness according to ambient temperature as well as variations over time. Thus, the present applicant has proposed a drive apparatus arranged such that, in order to compensate the brightness property, an EL monitoring element may be used to obtain the forward voltage and to control, based on the forward voltage, a supply voltage for causing and driving the EL display element to emit light. An example as mentioned above is disclosed in the following patent document 1.

[Patent Document 1]

Japanese Laid-open Patent No. 2004-252036

Incidentally, the above-mentioned light emitting panel has a dimmer function which generally controls the display brightness of the whole panel. An example of such a means for achieving such a dimmer function is electric current dimmer control. This electric current dimmer control is for controlling drive current supplied to the EL element which constitutes each pixel. In a particular example, it is possible to employ a structure as shown in FIG. 3.

In the structure as shown in FIG. 3, the dimmer setup value of a digital datum for setting up a dimmer value of a light emitting panel is converted into an analog control signal Vda by a D/A conversion means (not shown). This can be shown as a variable voltage supply which outputs the control signal Vda as indicated by reference numeral 1. This control signal Vda is arranged to be supplied to a current mirror circuit provided with a transistor Q3 which functions as a voltage/current conversion means via an operational amplifier 2 which constitutes a voltage buffer circuit, and to supply a monitoring EL element Ex with constant electric current based on the control signal Vda. In addition, it is arranged that an emitter potential of the transistor Q3 may be fed back to the above-mentioned operational amplifier 2, to thereby improve linearity of voltage/current conversion by means of the transistor Q3.

In the above-mentioned current mirror circuit, each emitter of pnp type transistors Q1 and Q2 is connected with a voltage supply Vcc and bases of transistors Q1 and Q2 are commonly connected. Further, the base and a collector of the transistor Q1 which constitutes an electric current controlling side are directly connected together.

The collector of the above-mentioned transistor Q1 is connected with a collector of the above-mentioned npn type transistor Q3 which functions as the voltage/current conversion means and whose emitter is connected to ground via a resistor R1. Further, it is arranged that a base of the transistor Q3 is supplied with a control signal based on the above-mentioned dimmer setup value from the operational amplifier 2.

According to the control signal based on the dimmer setup value, the above-mentioned transistor Q3 functions as a current suction circuit which operates on the current controlling side of the current mirror circuit, and operates so that the electric current corresponding to a current value Iin sunk by the transistor Q3 maybe supplied as constant electric current Iout to the monitoring element Ex connected to a collector of the transistor Q2 which is on a current-controlled side.

According to the structure of the above-mentioned current mirror circuit, as the above-mentioned dimmer setup value is changed and controlled, the current value Iin on the current controlling side is changed, whereby constant electric current Iout on the current-controlled side is also changed, which is supplied to the monitoring element Ex.

Then, the forward voltage Vf generated based on the constant electric current Iout supplied to the above-mentioned monitoring element Ex is held by a sample hold circuit 3, and the thus held forward voltage is arranged to be supplied as a control voltage to a DC-DC converter 4 as a drive voltage generating means. The above-mentioned DC-DC converter 4 constitutes, for example, a booster-type converter which uses a battery as a primary power supply, and the output voltage VA by means of this converter may be used as a drive voltage for the light emitting panel.

Therefore, the output voltage VA obtained by the above-mentioned converter 4 is used as a drive voltage according to the above-mentioned dimmer setup value, and a drive voltage for compensating the emission brightness of the light emitting element (EL element) arranged at the light emitting panel, corresponding to ambient temperature and variations over time.

Incidentally, in mobile computing devices etc., the above-mentioned dimmer setup value may be arranged to be automatically changed and controlled by detecting outdoor daylight, alternatively arranged to be manually changed and controlled. When the dimmer setup value is thus changed, especially when the dimmer value is changed to illuminate a screen brightly (increase in brightness), the resulting transient large current flows into the above-mentioned DC-DC converter 4 as the drive voltage generating means, the light emitting panel, and its drive circuit, etc., leading to a problem of applying stresses to and damaging elements constituting them and peripheral components.

FIG. 4 shows an example of voltage waveforms and current waveforms at respective parts in FIG. 3 when performing dimmer setup for raising the emission brightness, where (a) shows changes of the above-mentioned control signal Vda which rises by having performed the dimmer setup for raising the emission brightness. Further, (b), (c), and (d) respectively show a base potential Vb of the transistor Q3, the output current from the current mirror circuit, that is, the constant electric current value Iout to be supplied to the monitoring element Ex, and the forward voltage Vf generated in the monitoring element Ex. These voltage and current waveforms as indicated by (a)-(d) are substantially the same as the waveform as shown in the control signal Vda as indicated by (a).

On the other hand, (e) shows changes in output voltage of the drive voltage VA caused by the DC-DC converter 4, and this drive voltage rises with a delay of operational response of the sample hold circuit 3 and the DC-DC converter 4. Furthermore, (f) shows an example of converter inflow current Iba which flows from the battery into the DC-DC converter 4. As electric power energy outputted from the above-mentioned converter increases, a large current spike (peak current) flows instantaneously in order to follow the increase immediately.

The above-mentioned large current spike generated with re-setting up the dimmer value eventually applies stresses to the battery and the DC-DC converter 4, for example, and sometimes damages them. Further, a problem arises also in that the rise in the above-mentioned drive voltage VA applies stresses to the light emitting panel, the drive circuit which allows and drives it to emit light, etc., for example.

### SUMMARY OF THE INVENTION

In view of the above-mentioned technical problems, the present invention has been particularly made to provide a drive apparatus and drive method for a light emitting panel, employing dimmer control where transient peak current which is generated as a dimmer value is re-set up is inhibited, and adverse effects caused by the peak current can be eliminated.

According to a first preferable aspect of a drive apparatus for a light emitting panel in accordance with the present invention made in order to solve the above-mentioned problems, there is provided a drive apparatus for a light emitting panel in which one or a plurality of light emitting elements are arranged and the above-mentioned light emitting elements are caused and driven to emit light, the above-mentioned drive apparatus comprising, a control signal conversion means for changing, slowly or gradually over a predetermined time period, a control signal changed based on re-setup of a dimmer value for setting up emission brightness of the above-mentioned light emitting panel, and a drive voltage generation means for variably controlling a drive voltage supplied to the above-mentioned light emitting element based on output by means of the above-mentioned control signal conversion means.

Further, according to a second preferable aspect of the drive apparatus for the light emitting panel in accordance with the present invention, there is provided a drive apparatus for a light emitting panel in which one or a plurality of light emitting elements are arranged and the above-mentioned light emitting elements are caused and driven to emit light, the above-mentioned drive apparatus comprising, a control signal conversion means for changing, slowly or gradually over a predetermined time period, a control signal changed based on re-setup of a dimmer value for setting up emission brightness of the above-mentioned light emitting panel, and a drive current control means for variably controlling the drive current supplied to the above-mentioned light emitting element based on output by means of the above-mentioned control signal conversion means.

Further, according to a first preferable aspect of a drive method for a light emitting panel in accordance with the present invention made in order to solve the above-mentioned problems, there is provided a drive method for a light emitting panel in which one or a plurality of light emitting elements are arranged and the above-mentioned light emitting elements are caused and driven to emit light, wherein conversion operation is carried out for a control signal which changes, slowly or gradually over a predetermined time period, a control signal changed based on re-setup of a dimmer value for setting up emission brightness of the above-mentioned light emitting panel, and a drive voltage supplied to the above-mentioned light emitting element is variably controlled by means of the control signal after the above-mentioned conversion operation.

Further, according to a second preferable aspect of the drive method for the light emitting panel in accordance with the present invention, there is provided a drive method for a light emitting panel in which one or a plurality of light emitting elements are arranged and the above-mentioned light emitting elements are caused and driven to emit light, wherein conversion operation is carried out for a control signal which changes, slowly or gradually over a predetermined time period, a control signal changed based on re-setup of a dimmer value for setting up emission brightness of the above-mentioned light emitting panel, and the drive current supplied to the above-mentioned light emitting element is variably controlled by means of the control signal after the above-mentioned conversion operation.

### BRIEF DESCRIPTION OF THE DRAWINGS

FIG. 1 is an equivalent circuit diagram of an organic EL element;

FIGS. 2 are static characteristic graphs showing properties of the organic EL element;

FIG. 3 is a circuit block diagram showing an example of a drive apparatus having problems to be solved by the present invention;

FIG. 4 is a timing chart for explaining voltage waveforms and current waveforms at respective parts of a structure as shown in FIG. 3;

FIG. 5 is a circuit block diagram showing a first preferred embodiment of a drive apparatus in accordance with the present invention;

FIG. 6 is a timing chart for explaining voltage waveforms and current waveforms at respective parts of a structure as shown in FIG. 5;

FIG. 7 is a circuit block diagram showing a particular example of a DC-DC converter used in the structure as shown in FIG. 5;

FIG. 8 is a circuit block diagram showing an example of a light emitting panel which is controlled to emit light by using an output voltage by means of the structure as shown in FIG. 5;

FIG. 9 is a circuit block diagram showing a second preferred embodiment of the drive apparatus in accordance with the present invention;

FIG. 10 is a timing chart for explaining voltage waveforms and current waveforms at respective parts of a structure as shown in FIG. 9;

FIG. 11 is a circuit block diagram showing a third preferred embodiment of the drive apparatus in accordance with the present invention;

FIG. 12 is a circuit block diagram similarly showing a fourth preferred embodiment;

FIG. 13 is a circuit block diagram similarly showing a fifth preferred embodiment;

FIGS. 14 are a plan view and a sectional view of a liquid-crystal display panel showing an application where the drive apparatus in accordance with the present invention can be used; and

FIG. 15 is a block diagram showing another example of a circuit structure in the first preferred embodiment of the drive apparatus in accordance with the present invention.

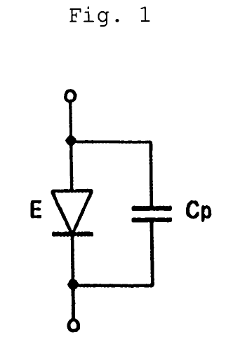

### DESCRIPTION OF THE PREFERRED EMBODIMENTS

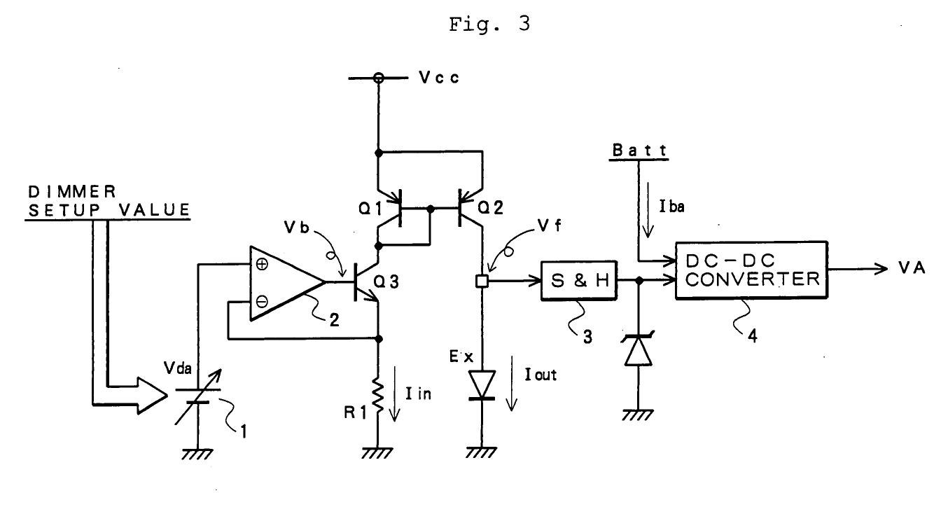

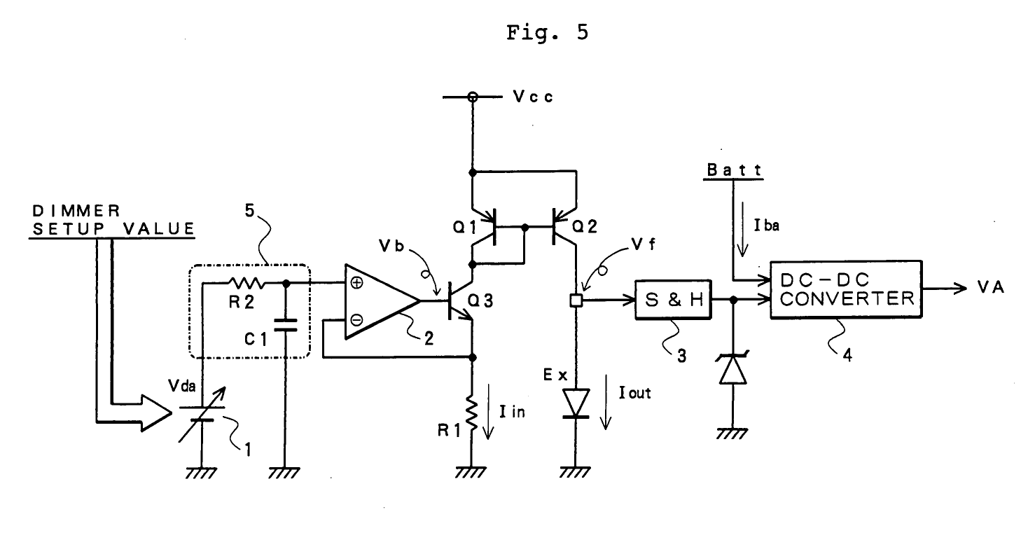

Hereafter, a drive apparatus for a light emitting panel in accordance with the present invention will be described with reference to preferred embodiments as shown in the drawings. FIG. 5 shows a first preferred embodiment of the light emitting panel. In FIG. 5, the same references are used for corresponding parts which achieve the same functions as those described with reference to FIG. 3, and therefore the detailed description of these parts may not be repeated.

The preferred embodiment as shown in FIG. 5 corresponds to the invention as recited in claim 1 and claim 16. In this preferred embodiment, a control signal conversion means 5 is employed which changes, slowly over a predetermined time period, the control signal Vda which is indicated by reference numeral 1 and changed based on the re-setup of the dimmer value. This signal conversion means is arranged such that a time constant circuit is constituted by a resistance element R2 and a capacitance element (capacitor) C1, and the above-mentioned control signal Vda through this time constant circuit is supplied to the above-mentioned operational amplifier 2 which constitutes a voltage buffer circuit.

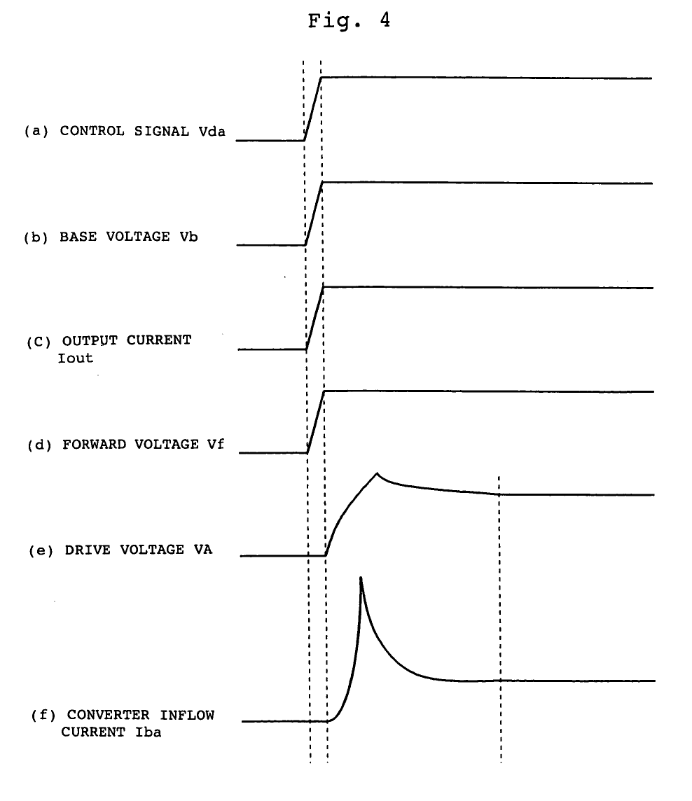

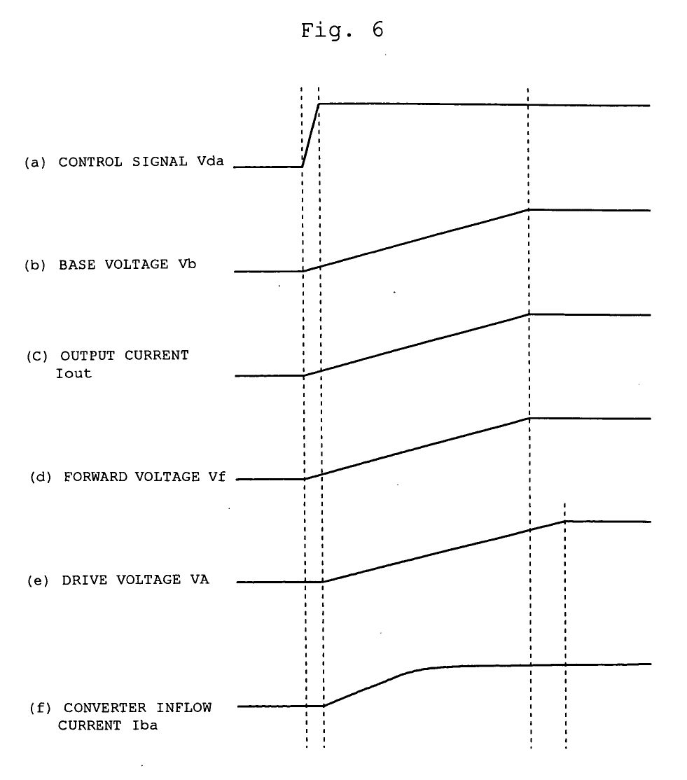

FIG. 6 shows an example of the voltage and current waveforms at respective parts as shown in FIG. 5 at the time of performing the dimmer setup for raising the emission brightness. Each of (a)-(f) in FIG. 6 corresponds to a respective one of (a)-(f) in FIG. 4, as already described. When the dimmer setup which raises the emission brightness of the light emitting panel is performed, the control signal Vda rises as shown in FIG. 6(a). Receiving this, the above-mentioned signal conversion means 5 operates according to its time constant so that a voltage supplied to the above-mentioned operational amplifier 2 may be slowly changed over a predetermined time period. Therefore, a base voltage Vb of the transistor Q3 has a waveform as shown in FIG. 6(b).

Thus, the constant electric current value Iout supplied to the monitoring element Ex as indicated by (c), and the forward voltage Vf generated at the monitoring element Ex as indicated by (d) respectively have substantially the same waveforms as that in FIG. 6(b). Further, the output voltage (drive voltage) VA outputted by the DC-DC converter 4 rises along with the slow rise of the forward voltage Vf generated at the above-mentioned monitoring element Ex, to have substantially the same waveform. Since, as described above, the output voltage is controlled by the DC-DC converter 4, a value of the current Iba which flows into the DC-DC converter 4 from the battery is controlled to rise slowly as shown in FIG. 6(f).

According to the structure employing the signal conversion means 5 as shown in FIG. 5, especially when the dimmer setup is carried out for raising the emission brightness, the current Iba which flows into the converter 4 from the battery can be inhibited from being a large rush current, whereby it is possible to remove the problem of applying stresses to the battery, the DC-DC converter 4, etc. Further, since the drive voltage VA outputted from the DC-DC converter 4 is also inhibited from changing rapidly, it is possible to eliminate the problem of applying stresses to the light emitting panel, the drive circuit for causing and driving the panel to emit light, etc.

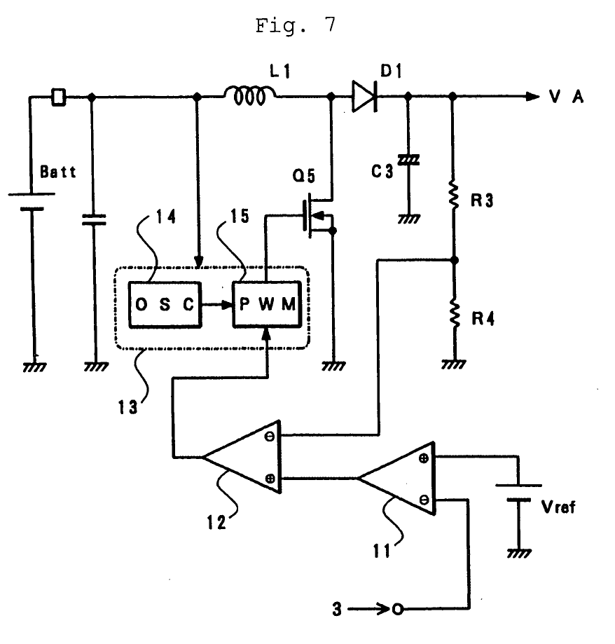

FIG. 7 explains a particular example of the DC-DC converter shown as reference numeral 4 in FIG. 5. In other words, output from the sample hold circuit 3 as shown in FIG. 5 (control input to the converter) is arranged to be supplied to one input terminal (inversing input terminal) of an error amplifier 11 of an operational amplifier as shown in FIG. 7. Further, a reference voltage Vref is supplied to the other input terminal (non-inversing input terminal) in the above-mentioned error amplifier 11, therefore a comparison output (error output), comparison between the output from the sample hold circuit 3 and the reference voltage Vref, is generated in the error amplifier 11.

Further, the output by means of the error amplifier 11 is arranged to be supplied to one input terminal (non-inversing input terminal) in an error amplifier 12 of an operational amplifier. Furthermore, the other input terminal (inversing input terminal) in the error amplifier 12 is arranged to be supplied with voltage-divided output by means of resistance elements R3 and R4 which divide the output voltage VA in the DC-DC converter. Therefore, the output voltage value in the error amplifier 12 includes both output information data of the output from the above-mentioned sample hold circuit 3 and the output VA in the DC-DC converter.

In the structure as shown in FIG. 7, a booster-type DC-DC converter is used, and the output in the above-mentioned error amplifier 12 is arranged to be supplied to a switching-signal generation circuit 13. This switching-signal generation circuit 13 is provided with a reference sawtooth wave (triangular wave) oscillator 14 and a PWM (pulse width modulation) circuit 15. A comparator (not shown) is provided for the above-mentioned PWM circuit 15. This comparator is supplied with the output from the above-mentioned error amplifier 12 and a sawtoothwave (triangular wave) from the reference sawtooth wave oscillator 14, so that a PWM signal is generated from the PWM circuit 15.

A pulse signal from the above-mentioned PWM circuit 15 is arranged to be supplied to a gate of a power FET Q5, so as to switch the FET Q5. In other words, power energy from a battery Batt is accumulated in an inductor L1 by switching ON the above-mentioned FET Q5. On the other hand, as the FET Q5 is subjected to OFF operation, the power energy accumulated in the above-mentioned inductor is accumulated in a capacitor C3 via a diode D1.

By repeating the on/off operation of the above-mentioned FET Q5, the boosted (rise in voltage) DC output can be obtained as a terminal voltage of the capacitor C3, so as to be the output voltage VA from the converter. As described above, this output voltage VA is divided by the resistance elements R3 and R4, and fed back to the error amplifier 12, so that the output voltage VA is maintained constantly. Thus, it is possible to supply the drive voltage VA which can realize the brightness compensation and the dimmer control corresponding to an operating temperature and variations over time in the light emitting elements of the light emitting panel.

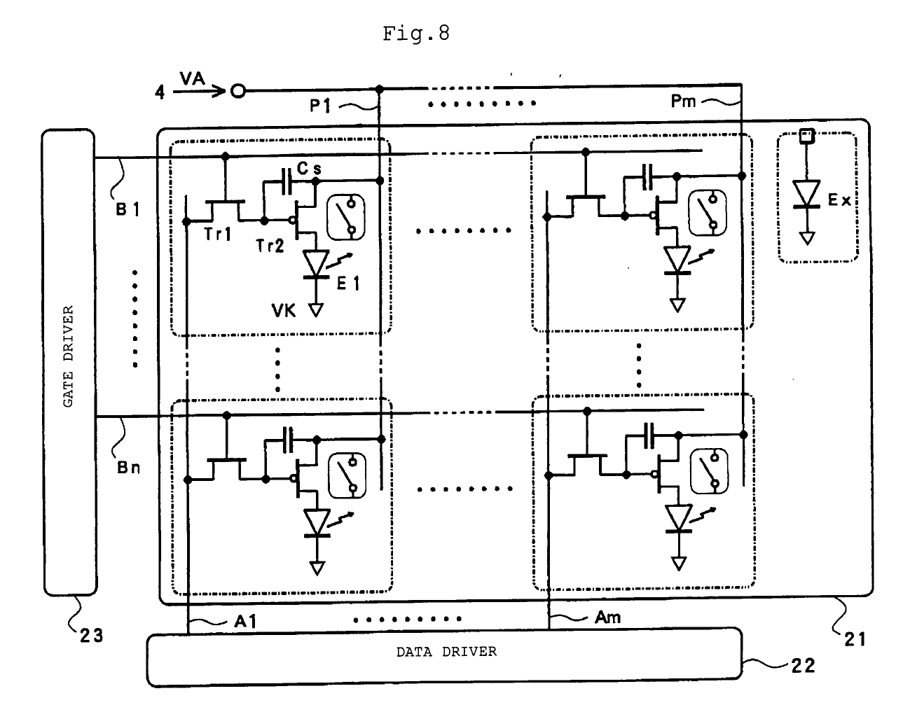

FIG. 8 shows an example of an active-matrix type light emitting panel which causes and drives each light emitting element to emit light by using the drive voltage VA supplied from the above-mentioned DC-DC converter 4. In addition, given the limited space in the paper, FIG. 8 shows only a partial structure of four pixels arranged at four corners of a light emitting panel 21, and pixels located among the four pixels are not shown.

As shown in FIG. 8, data lines A1-Am to which data signals are supplied from a data driver 22 are vertically arranged in the light emitting panel 21, and scanning selection lines B1-Bn to which scanning selection signals are supplied from a gate driver 23 are horizontally arranged. Furthermore, power supply lines P1-Pm are vertically arranged in the light emitting panel 21, respectively corresponding to the above-mentioned data lines. These power supply lines are arranged to be provided with the drive voltage VA supplied from the DC-DC converter 4 as shown in FIG. 5 (FIG. 7).

As shown, each of the pixels arranged in the light emitting panel 21 has a pixel construction by way of a conductance control method, for example. In other words, as each element which constructs the pixel of the upper left corner as shown in FIG. 8 is indicated by reference, a gate of a control transistor Tr1 constituted by an n-channel type TFT is connected to the scanning selection line B1, and a source is connected to the data line A1. Further, a drain of the control transistor Tr1 is connected to a gate of a driving transistor Tr2 constituted by a p-channel type TFT and also connected with one terminal of a charge storing capacitor Cs.

And a source of the driving transistor Tr2 is connected to the other terminal of the above-mentioned capacitor Cs and connected with the power supply line P1. Further, an anode of an organic EL element E1 as a light emitting element is connected to the drain of the driving transistor, and a cathode of the EL element E1 is connected to a common electrode on the cathode side as indicated by a voltage value VK.

In the above-mentioned pixel construction, when an ON-state voltage is supplied to the gate of the control transistor Tr1 from the gate driver 33 via the scanning selection line B1, the control transistor TR1 causes the electric current corresponding to a data voltage supplied to the source from the data line A1 to flow from the source to the drain. Therefore, while the gate of the control transistor TR1 is the ON-state voltage, the above-mentioned capacitor Cs is charged and its voltage is supplied to the gate of the driving transistor Tr2.

Therefore, the driving transistor Tr2 is turned on based on its gate-source voltage, applies the drive voltage VA (supplied from the above-mentioned DC-DC converter 4) to the EL element E1, and causes and drives the EL element to emit light. In other words, the driving transistor Tr2 which is constituted by the TFT in this preferred embodiment is arranged such that switching operations (operations in linear region) may be carried out between two modes, ON and OFF, by the data voltage supplied from the data driver.

On the other hand, when the gate of the control transistor TR1 is an OFF state voltage, the transistor is so-called cut off and the drain of the control transistor TR1 is in an open state. However, the gate voltage is held by the charge accumulated in the capacitor Cs, and the driving transistor Tr2 maintains the state of applying the above-mentioned drive voltage VA to the EL element E1 until the next scan, whereby the light emission of the EL element E1 is also maintained.

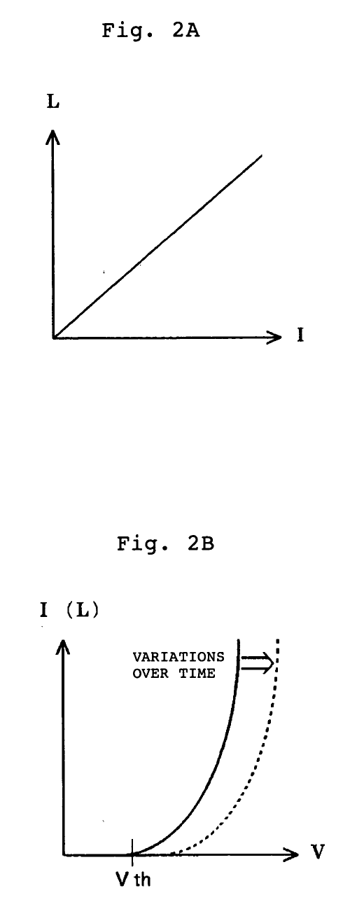

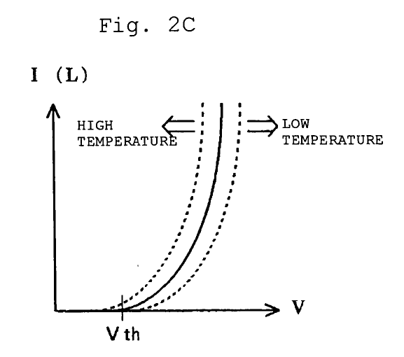

As already described, the drive voltage VA supplied from the above-mentioned DC-DC converter 4 is caused to be the drive voltage according to the setup of the above-mentioned dimmer value, and to be the drive voltage for compensating the emission brightness corresponding to ambient temperature and variations over time of the EL elements arranged in the light emitting panel. Therefore, the EL element E1 which constitutes each pixel is selectively supplied with the above-mentioned drive voltage VA and controlled to emit light along the V-I (L) properties as shown in FIG. 2.

In addition, reference Ex located at an edge of the light-emitting panel 21 as shown in FIG. 8 indicates the above-mentioned monitoring element. This monitoring element Ex is simultaneously formed at the time of forming each display element E1 arranged in the light-emitting panel. In other words, if both the display element E1 and the monitoring element Ex are organic EL elements, then they have the same variations over time and emission brightness properties dependent on the temperature by forming them as a film on a substrate of the panel 31 simultaneously.

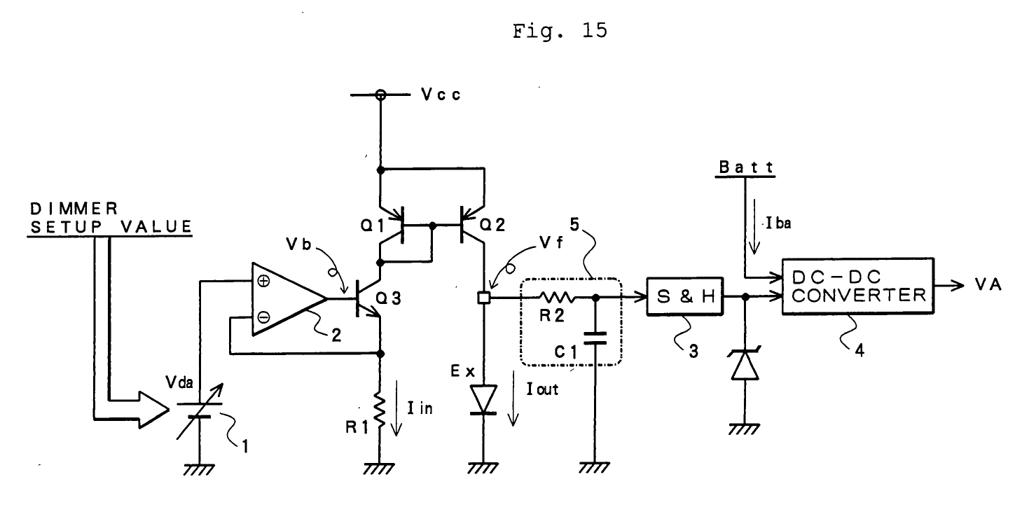

In addition, in the preferred embodiment as shown in FIG. 5, although the circuit structure is shown in which the control signal Vda is changed slowly over a predetermined time period by means of the control signal conversion means 5 constituted by the time constant circuit, the structure for inhibiting the transient peak current generated as the dimmer value is re-set up is not limited to the circuit structure. For example, the control signal conversion means 5 constituted by the time constant circuit as shown in FIG. 15 may be provided between the collector of the transistor Q2 and an input side of the sample hold circuit 3.

According to the structure as shown in FIG. 15, the rapid rise of the forward voltage Vf can be eased by the control signal conversion means 5, so as to be outputted to the following sample hold circuit 3, thus eliminating adverse effects caused by the rapid change of the forward voltage Vf.

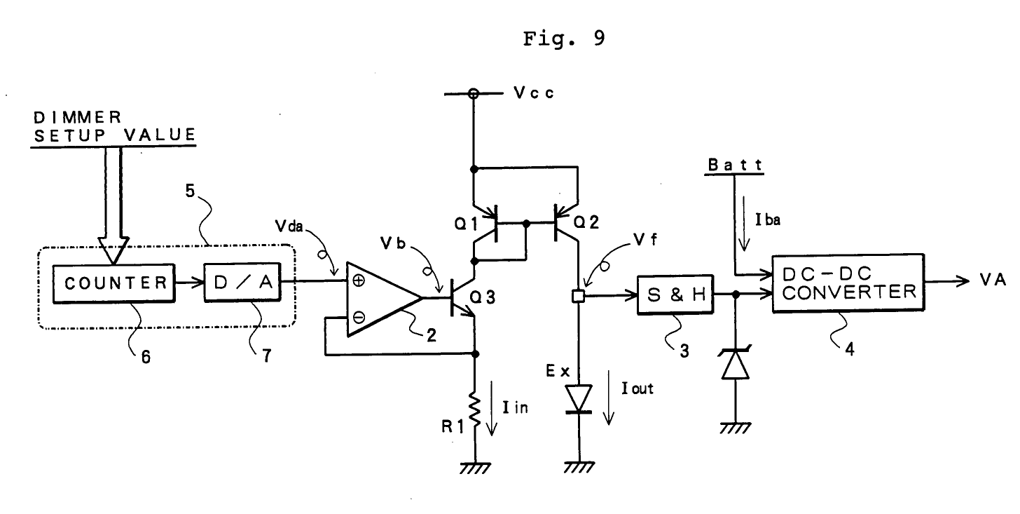

FIG. 9 shows a second preferred embodiment of the drive apparatus in accordance with the present invention. In addition, in FIG. 9, the same references are used for corresponding parts which achieve the same functions as those described with reference to FIGS. 3 and 5, and therefore the detailed description of these parts may not be repeated.

The preferred embodiment as shown in FIG. 9 corresponds to the invention as recited in claims 6 to 8 and 21 to 23. In this preferred embodiment, the control signal conversion means 5 is employed to change gradually the control signal changed based on the setup of the dimmer value, and to supply it to the DC-DC converter as a drive voltage generation means. As shown, this signal conversion means 5 is provided with a counter 6 and a D/A converter 7, and arranged to obtain dimmer control data by way of digital processing.

In other words, the dimmer data newly set up based on the re-setup of the dimmer value are stored in a register (not shown), for example, and the counter 6 operates so as to shift up the data gradually toward the re-set up dimmer setup data. A digital datum from this counter 6 is arranged to be changed into analog data by means of the D/A converter 7, and to be supplied to the above-mentioned operational amplifier 2 which constitutes the voltage buffer circuit.

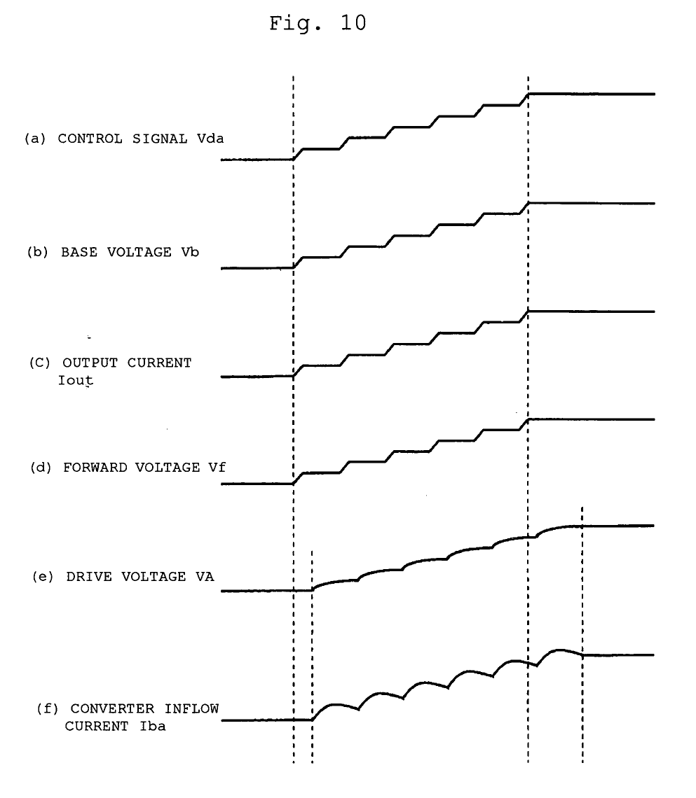

FIG. 10 shows an example of the voltage and current waveforms at respective parts in the structure as shown in FIG. 9 at the time of performing the dimmer value re-setup for raising the emission brightness. Each of (a)-(f) in FIG. 10 corresponds to a respective one of (a)-(f) in FIG. 4, as already described. When the dimmer setup which raises the emission brightness is performed, the analog control signal Vda which rises gradually as shown in FIG. 10(a) is generated by the signal conversion means constituted by the above-mentioned counter 6 and D/A converter 7. This analog control signal Vda is supplied to the above-mentioned operational amplifier 2 which constitute the voltage buffer circuit.

Thus, as shown in FIG. 10, the base voltage Vb of the transistor Q3 as indicated by (b), the constant electric current value Iout supplied to the monitoring element Ex as indicated by (c), and the forward voltage Vf generated at the monitoring element Ex as indicated by (d) respectively have substantially the same waveforms as that in FIG. 10(a) . Further, the output voltage (drive voltage) VA outputted by the DC-DC converter 4 rises along with the gradual rise of the forward voltage Vf generated at the above-mentioned monitoring element Ex, to have substantially the same waveform. Since, as described above, the output voltage is controlled by the DC-DC converter 4, changes of the current Iba which flows into the DC-DC converter 4 from the battery are inhibited to the extent of having ripple components as shown in FIG. 10(f).

Therefore, also in the structure where the signal conversion means 5 as shown in FIG. 9 is employed, when the dimmer setup for raising the emission brightness, for example, is carried out, the current Iba which flows into the converter 4 is not accompanied by a large rush current, so that the peak can be effectively inhibited from generating. This provides operational effects similar to those in the first preferred embodiment as shown in FIG. 5.

In addition, the structures shown in FIGS. 7 and 8 as already described can be employed for a particular structure of the light emitting panel which is caused and driven to emit light by using the DC-DC converter 4 in the structure as shown in FIG. 9, and the drive voltage VA supplied from this converter 4.

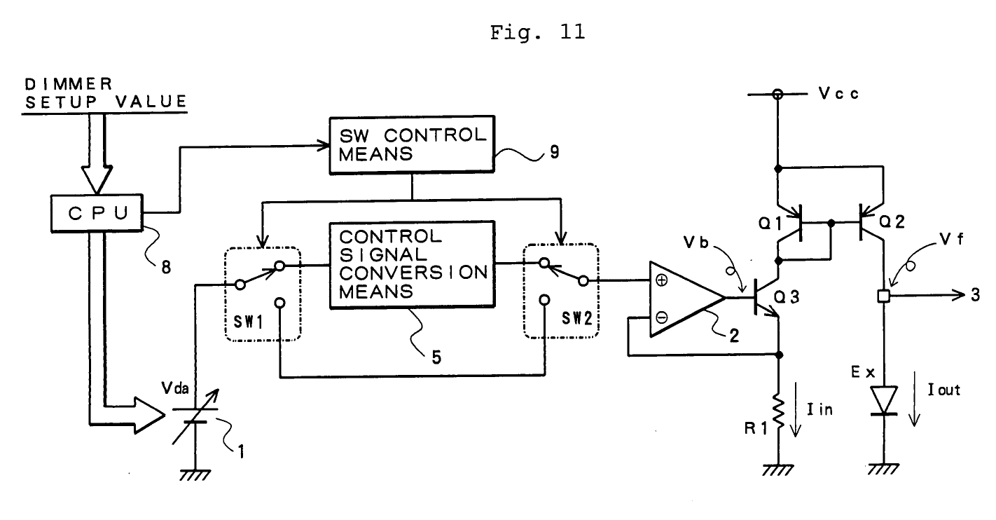

FIG. 11 shows a third preferred embodiment of the drive apparatus in accordance with the present invention. In FIG. 11, the same references are used for corresponding parts which achieve the same functions as those described with reference to FIGS. 5 and 9, and therefore the detailed description of these parts may not be repeated. In addition, the structure after the sample hold circuit 3 is not shown in FIG. 11.

The preferred embodiment as shown in FIG. 11 corresponds to the invention as recited in claims 3, 4, 19, and 20. In this preferred embodiment, in the case where the changes of the above-mentioned control signal based on the re-setup of the above-mentioned dimmer value raise the emission brightness of the light emitting panel, and additionally when a variation of the above-mentioned control signal is equal to or greater a predetermined value, it is arranged that the output by means of the control signal conversion means 5 may be used.

In other words, when raising the emission brightness of the light emitting panel by way of the re-setup of the above-mentioned dimmer value, the power supplied to the DC-DC converter from the battery rises instantaneously, so that the phenomenon that the current value supplied to the DC-DC converter from the battery rises extremely occurs. Conversely, when reducing the emission brightness of the light emitting panel the phenomenon described above does not occur.

Therefore, in the preferred embodiment as shown in FIG. 11, the dimmer setup value is arranged to be supplied to a CPU (central operation unit) 8, and it is arranged that the analog control signal Vda based on the dimmer setup value is obtained via the CPU 8. Further, the above-mentioned CPU 8 is provided with a determination means which determines whether or not the emission brightness of the light emitting panel is raised by way of the re-setup of the dimmer value, and determines whether or not the rise value (variation) is equal to or greater than a predetermined value. The determination means may be a hard ware device or software.

In the above-mentioned determination means provide for the CPU 8, when it is determined that the above-mentioned conditions are satisfied, instructions are sent from the CPU 8 to a switch control means 9. As shown in FIG. 11, a first switch SW1 and a second switch SW2 are arranged to connect to the control signal conversion means 5 sides. In addition, the control signal conversion means 5 as shown in FIG. 11 is constituted by the time constant circuit of the resistance element R2 and the capacitor C1 as shown in FIG. 5 as an example. Thus, the control signal Vda as shown by a variable voltage supply 1 is supplied to an operational amplifier 2 through the control signal conversion means 5, so that operational effects similar to those of the preferred embodiments as shown in FIGS. 5 and 6 can be obtained.

Furthermore, in the above-mentioned determination means provided for the CPU 8, when it is determined that the above-mentioned conditions are not satisfied, the first switch SW1 and the second switch SW2 are switched to a state opposite to the state as shown in FIG. 11, and the control signal conversion means 5 does not perform signal conversion operation.

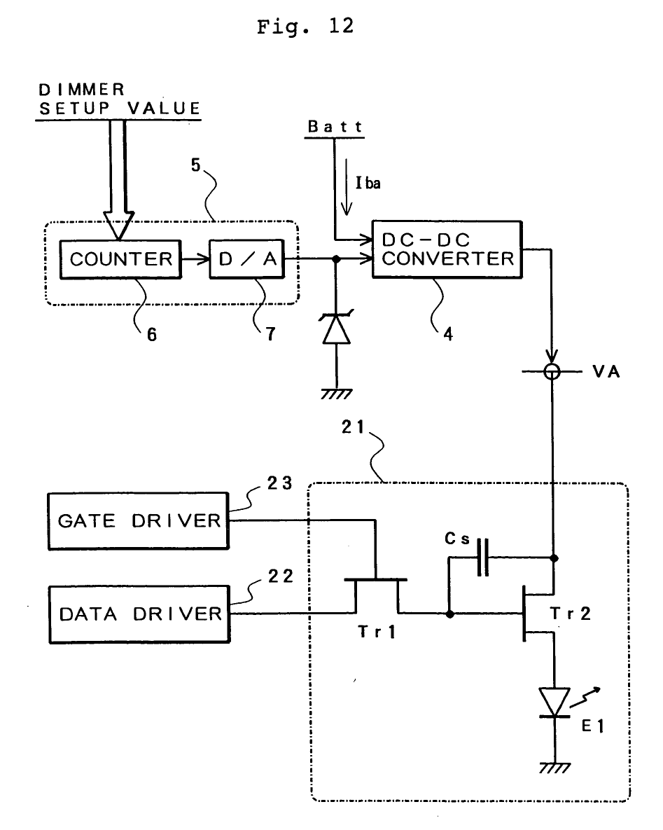

As for the above description, the example is provided in which the brightness compensation for the variations over time and temperature dependency of each light emitting element arranged in the light emitting panel is realized by using the monitoring element Ex. However, the present invention can also be employed in the drive apparatus for the light emitting panel which does not use the above-mentioned monitoring element. FIG. 12 shows an example of it.

Shown in FIG. 12 is the light emitting panel 21 exemplified by one pixel construction, in which the pixel construction by way of the conductance control method is illustrated similarly to the example as explained with reference to FIG. 8, and the same references are respectively used for corresponding elements. Further, similarly to the example as shown in FIG. 8, the gate and the source of the control transistor TR1 are arranged to be respectively supplied with the scanning selection signal and the data signal from the gate driver 23 and the data driver 22.

In the preferred embodiment as shown in FIG. 12, similarly to the example as shown in FIG. 9, the control signal based on the dimmer setup is supplied as a control input signal to the DC-DC converter via the control signal conversion means 5 for the counter 6 and the D/A converter 7. Also in this structure, when the dimmer setup for raising the brightness of the light emitting panel is carried out, the intense rush current supplied from the battery to the DC-DC converter 4 can be eased, thus providing the operational effects similar to those in the preferred embodiments as already described.

In addition, in the preferred embodiment as shown in FIG. 12, although the control signal conversion means 5 constituted by the counter 6 and the D/A converter 7 is employed, alternatively it is also possible to employ the signal conversion means of the time constant circuit constituted by the resistance element R2 and the capacitor C1 as shown in FIG. 5.

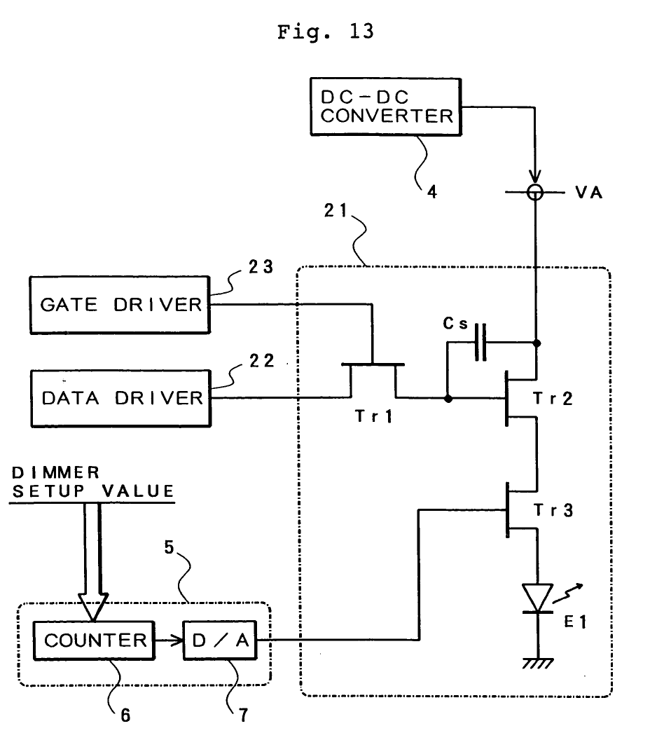

Like the preferred embodiment as shown in FIG. 12, FIG. 13 shows an example of the drive apparatus for the light emitting panel which does not use the monitoring element as described above. In FIG. 13, the same references are used for corresponding parts which achieve the same functions as those described with reference to FIG. 12, and therefore the detailed description of these parts may not be repeated. In addition, this preferred embodiment corresponds to the invention as recited in claims 2 and 17.

The preferred embodiment as shown in FIG. 13 may be suitably employed in the drive apparatus for the light emitting panel provided with the pixel construction in which the charge based on the data signal from the data driver 22 is charged in the capacitor Cs, and the driving transistor Tr2 functions as a constant current drive element by means of a quantity of the charge charged in the capacitor Cs, i.e., a charge voltage value of the capacitor Cs.

Also in the structure as shown in FIG. 13, when the dimmer setup value for raising the brightness of the light emitting panel is employed, the intense rush current is supplied from the battery to the DC-DC converter 4 in order to compensate the rise of the power consumption in the light emitting panel, similarly to the example as shown in FIG. 4(f). In order to avoid such a phenomenon, in the structure as shown in FIG. 13, a transistor Tr3 as a drive current control means which can variably control the drive current supplied to the EL element E1 is arranged for every pixel.

In other words, although the above-mentioned transistor Tr3 as the drive current control means is connected between the driving transistor Tr2 and the EL element E1, it may only be connected in series to any place of the driving transistor Tr2 and the EL element E1. In addition, it is arranged that the control signal changed based on the re-setup of the dimmer value is supplied to a gate of the above-mentioned transistor Tr3 via the control signal conversion means 5.

The above-mentioned control signal conversion means 5 is similar to that of the example as shown in FIG. 9 including the counter 6 and the D/A converter 7. Thus, when the dimmer setup value for raising the brightness of the light emitting panel is employed, a direct current resistance value between the drain and the source of the above-mentioned transistor Tr3 is controlled to become smaller gradually according to the operation of the control signal conversion means 5. Therefore, also in the structure as shown in FIG. 13, the intense rush current supplied from the battery to the DC-DC converter 4 can be eased by way of the dimmer setup for raising the brightness of the light emitting panel.

In addition, also in the preferred embodiment as shown in FIG. 13, although the structure of the counter 6 and the D/A converter 7 is employed as the control signal conversion means 5, alternatively it is also possible to employ the signal conversion means of the time constant circuit constituted by the resistance element R2 and the capacitor C1 as shown in FIG. 5.

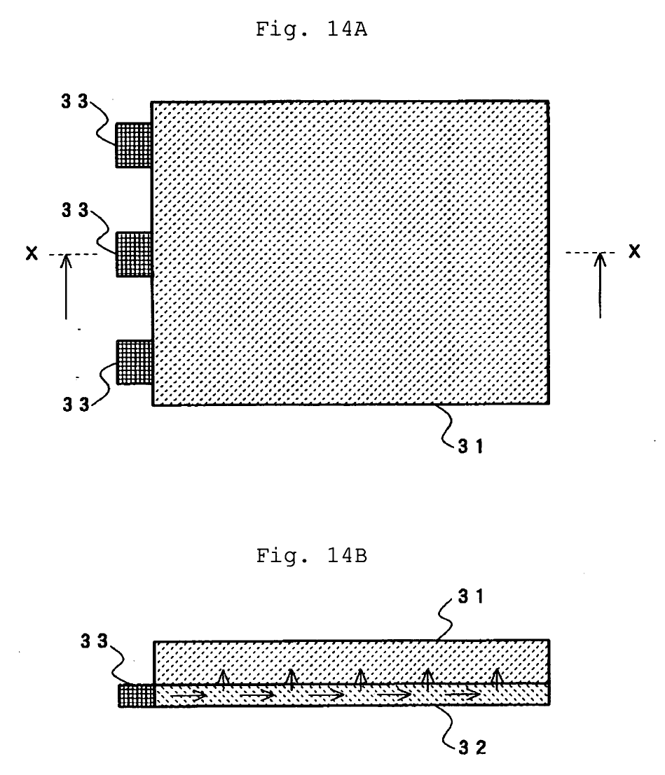

In any one of the preferred embodiments as described above, although the plurality of light emitting elements are arranged on the panel, and the above-mentioned light emitting elements are selectively caused and driven to emit light so as to display the image, the present invention can be employed in not only the above-mentioned structure but also the drive apparatus for the light emitting panel which functions as the back light of a liquid-crystal display panel, for example. FIG. 14 schematically shows an example of it, where (A) shows a liquid-crystal display panel when viewed in plan, and (B) shows it by a cross section when viewed along X-X line in (A) in the direction of the arrows.

In FIG. 14, reference numeral 31 indicates a liquid crystal panel, and a light conducting plate 32 formed of a synthetic resin is attached to the back of this liquid crystal panel. Further, in the preferred embodiment as shown in FIG. 14, it is arranged that three LED's 33 as light emitting elements are disposed at an end face of the above-mentioned light conducting plate 32, and light from the LED is introduced from each LED towards the above-mentioned light conducting plate 32.

With this structure, the light from the LED's is introduced into the light conducting plate 32, acts to pass through the panel 31 from the back of the liquid crystal panel 31 towards its front, and functions as a back light of the liquid crystal panel. In the preferred embodiment as shown in FIG. 14, the light emitting panel is formed by the above-mentioned LED's 33 and the light conducting plate 32. Based on the setup of the dimmer value, the drive voltage or the drive current supplied to the above-mentioned LED's 33 is variably controlled, so that the substantial brightness of the above-mentioned liquid crystal panel 31 can be changed.

Therefore, each of the preferred embodiments as already described can suitably be employed as the drive voltage generation means or the drive current control means which causes and drives the LED's 33 to emit light, based on the setup of the dimmer value, to thereby obtain similar operational effects.

The above-described drive apparatus for the light emitting panel in accordance with the present invention can be applied not only to the drive apparatus for the active-matrix type light emitting panel as shown in FIG. 8, but also to a drive apparatus for a passive-matrix type light emitting panel (not shown). Further, in the above-described preferred embodiments, although the example is shown in which the organic EL elements are used as the light emitting elements for display and a monitoring element arranged at the light emitting panel, the light emitting panel can enjoy the same brightness compensation operation, even when light emitting elements of another type are used which has the variations over time and the temperature dependency as shown in FIG. 2.

What is claimed is:

1. A drive apparatus for a light emitting panel in which one or a plurality of light emitting elements are arranged and said light emitting elements are caused and driven to emit light, said drive apparatus comprising:
a control signal conversion means for changing, slowly or gradually over a predetermined time period, a control signal changed based on re-setup of a dimmer value for setting up emission brightness of said light emitting panel; and
a drive voltage generation means for variably controlling a drive voltage supplied to said light emitting element based on output by means of said control signal conversion means.

2. A drive apparatus for a light emitting panel in which one or a plurality of light emitting elements are arranged and said light emitting elements are caused and driven to emit light, said drive apparatus comprising:
a control signal conversion means for changing, slowly or gradually over a predetermined time period, a control signal changed based on re-setup of a dimmer value for setting up emission brightness of said light emitting panel; and
a drive current control means for variably controlling drive current supplied to said light emitting element based on output by means of said control signal conversion means.

3. The drive apparatus for the light emitting panel as claimed in claim 1 or 2, wherein when a change in said control signal based on re-setup of said dimmer value increases the emission brightness of said light emitting panel, the output by means of said control signal conversion means may be used.

4. The drive apparatus for the light emitting panel as claimed in claim 1 or 2, wherein when a variation in said control signal based on re-setup of said dimmer value is equal to or greater than a predetermined value, the output by means of said control signal conversion means may be used.

5. The drive apparatus for the light emitting panel as claimed in claim 1 or 2, wherein said control signal conversion means is constituted by a time constant circuit including a resistance element and a capacitance element, and arranged to change, slowly over a predetermined time period, said control signal changed based on re-setup of said dimmer value.

6. The drive apparatus for the light emitting panel as claimed in claim 1 or 2, wherein said control signal conversion means is constituted by a counter and a D/A converter, and arranged to gradually change said control signal changed based on re-setup of said dimmer value.

7. The drive apparatus for the light emitting panel as claimed in claim 3, wherein said control signal conversion means is constituted by a counter and a D/A converter, and arranged to gradually change said control signal changed based on re-setup of said dimmer value.

8. The drive apparatus for the light emitting panel as claimed in claim 4, wherein said control signal conversion means is constituted by a counter and a D/A converter, and arranged to gradually change said control signal changed based on re-setup of said dimmer value.

9. The drive apparatus for the light emitting panel as claimed in claim 1, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

10. The drive apparatus for the light emitting panel as claimed in claim 3, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

11. The drive apparatus for the light emitting panel as claimed in claim 4, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

12. The drive apparatus for the light emitting panel as claimed in claim 5, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

13. The drive apparatus for the light emitting panel as claimed in claim 6, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

14. The drive apparatus for the light emitting panel as claimed in claim 7, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

15. The drive apparatus for the light emitting panel as claimed in claim 8, wherein it is arranged that the constant electric current value to be supplied to the monitoring element is controlled by the control signal supplied via said control signal conversion means, and the control voltage obtained based on the forward voltage generated at said monitoring element is supplied to said drive voltage generating means.

16. A drive method for a light emitting panel in which one or a plurality of light emitting elements are arranged and said light emitting elements are caused and driven to emit light, wherein
a control signal changed based on re-setup of a dimmer value for setting up emission brightness of said light emitting panel is subjected to conversion operation for a control signal which is changed slowly or gradually over a predetermined time period, and a drive voltage supplied to said light emitting element is variably controlled by means of the control signal after said conversion operation.

17. A drive method for a light emitting panel in which one or a plurality of light emitting elements are arranged and said light emitting elements are caused and driven to emit light, wherein
a control signal changed based on re-setup of a dimmer value for setting up emission brightness of said light emitting panel is subjected to conversion operation for a control signal which is changed slowly or gradually over a predetermined time period, and drive current supplied to said light emitting element is variably controlled by means of the control signal after said conversion operation.

18. The drive method for the light emitting panel as claimed in claim 16 or 17, wherein when a change in said control signal based on the re-setup of said dimmer value increases the emission brightness of said light emitting panel, the output by way of said control signal conversion operation may be used.

19. The drive method for the light emitting panel as claimed in claim 16 or 17, wherein when a variation in said control signal based on the re-setup of said dimmer value is equal to or greater than a predetermined value, the output by way of said control signal conversion operation may be used.

20. The drive method for the light emitting panel as claimed in claim 16 or 17, wherein said control signal changed based on the re-setup of said dimmer value is converted by a time constant circuit including a resistance element and a capacitance element, into a control signal which changes slowly over a predetermined time period.

21. The drive method for the light emitting panel as claimed in claim 16 or 17, wherein said control signal changed based on the re-setup of said dimmer value is converted by a combined structure of a counter and a D/A converter, into a control signal which changes gradually.

22. The drive method for the light emitting panel as claimed in claim 18, wherein said control signal changed based on the re-setup of said dimmer value is converted by a combined structure of a counter and a D/A converter, into a control signal which changes gradually.

23. The drive method for the light emitting panel as claimed in claim 19, wherein said control signal changed based on the re-setup of said dimmer value is converted by a combined structure of a counter and a D/A converter, into a control signal which changes gradually.

24. The drive method for the light emitting panel as claimed in claim 16, wherein the constant electric current value to be supplied to the monitoring element is controlled by the control signal based on the re-setup of said dimmer value, and the drive voltage supplied to said light emitting panel is variably controlled based on the forward voltage generated at said monitoring element.
